(19) United States
(12) Patent Application Publication
(10) Pub. No.: US 2025/0015370 A1
(43) Pub. Date: Jan. 9, 2025

(54) COMMUNICATION DEVICE AND OPERATION METHOD OF COMMUNICATION DEVICE

(71) Applicant: TOYOTA JIDOSHA KABUSHIKI KAISHA, Toyota-shi (JP)

(72) Inventor: Eiji OKAZAKI, Higashi-hiroshima-shi (JP)

(73) Assignee: TOYOTA JIDOSHA KABUSHIKI KAISHA, Toyota-shi (JP)

(21) Appl. No.: 18/668,803

(22) Filed: May 20, 2024

(30) Foreign Application Priority Data
Jul. 7, 2023 (JP) 2023-112566

(51) Int. Cl. H01M 10/42; H01M 10/48; H02J 7/00

(52) U.S. Cl. CPC H01M 10/425; H01M 10/482; H02J 7/0047; H01M 2010/4278

(57) ABSTRACT

A communication device includes: a communication unit; and a control unit that executes an activation process by receiving electricity supply from an external battery or sends a report through the communication unit by receiving electricity supply from an internal battery instead of the external battery, when an electric power source is turned on, in which the control unit has a first mode in which the control unit continues the activation process by the electricity supply from the internal battery, when the electricity supply from the external battery is stopped during the execution of the activation process.

### CROSS-REFERENCE TO RELATED APPLICATION

This application claims priority to Japanese Patent Application No. 2023-112566 filed on Jul. 7, 2023, incorporated herein by reference in its entirety.

### BACKGROUND

### 1. Technical Field

The present disclosure relates to a communication device and an operation method of a communication device.

### 2. Description of Related Art

There is known a communication device that is equipped in a vehicle and that sends position information, registration information and others about the vehicle, to the police, the fire department, or the like, at the time of occurrence of an accident, for example. For example, Japanese Unexamined Patent Application Publication No. 2000-278885 and Japanese Unexamined Patent Application Publication No. 2017-182430 disclose in-vehicle emergency report systems each of which includes a main battery and an auxiliary battery.

### SUMMARY

The in-vehicle communication device has room for improvement in the method of the electricity supply from in-vehicle batteries.

The present disclosure relates to an in-vehicle communication device and the like that allow the improvement of the electricity supply method.

A communication device in the present disclosure includes: a communication unit; and a control unit that executes an activation process by receiving electricity supply from an external battery or sends a report through the communication unit by receiving electricity supply from an internal battery instead of the external battery, when an electric power source is turned on, in which the control unit has a first mode in which the control unit continues the activation process by the electricity supply from the internal battery, when the electricity supply from the external battery is stopped during the execution of the activation process.

An operation method of a communication device in the present disclosure is an operation method of a communication device that includes a communication unit and a control unit, in which: the control unit executes an activation process by receiving electricity supply from an external battery or sends a report through the communication unit by receiving electricity supply from an internal battery instead of the external battery, when an electric power source is turned on; and in a first mode, the control unit continues the activation process by the electricity supply from the internal battery, when the electricity supply from the external battery is stopped during the execution of the activation process.

The in-vehicle communication device and the like in the present disclosure allow the improvement of the electricity supply method.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an exemplary configuration of a communication device;

FIG. 2 is a diagram showing an exemplary operation procedure of the communication device; and

FIG. 3 is a diagram showing an exemplary operation procedure of the communication device.

### DETAILED DESCRIPTION OF EMBODIMENTS

An embodiment will be described below with reference to the drawings.

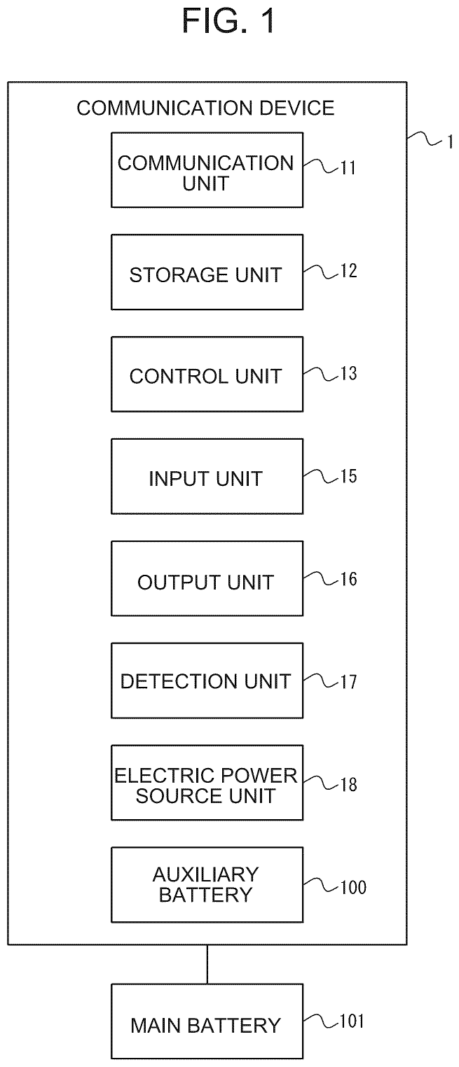

FIG. 1 is a diagram showing an exemplary configuration of a communication device in an embodiment. A communication device 1 is a so-called data communication module (DCM) that is equipped in a vehicle and that exchanges information generated based on the operation of the vehicle, information for controlling the operation of the vehicle, and the like, with a cloud server or the like. The communication device 1 operates by electric power that is supplied from a main battery 101 of the vehicle or an auxiliary battery 100 built in the communication device 1. The main battery 101 is a battery that is equipped in the vehicle and that supplies electric power for driving the vehicle and parts of the vehicle. For example, the main battery 101 and the auxiliary battery 100 include one or more lithium-ion batteries.

The communication device 1 includes a communication unit 11 and a control unit 13. When an electric power source is turned on, the control unit 103 executes an activation process by receiving electricity supply from an external battery, that is, the main battery 101, or sends a report through the communication unit by receiving electricity supply from an internal battery, that is, the auxiliary battery 100, instead of the main battery 101. Further, the control unit 13 has a mode in which the control unit 13 continues the activation process by the electricity supply from the auxiliary battery 100, when the electricity supply from the main battery 101 is stopped during the execution of the activation process.

When an ACC power source of the vehicle is turned on by a user, or when an electric power source switch of the communication device 1 is turned on by the user, the communication device 1 is activated by receiving the electricity supply from the main battery 101. Further, when the communication device 1 and the main battery 101 are electrically disconnected in the vehicle due to the occurrence of an accident or the like, the communication device 1 receives the electricity supply from the auxiliary battery 100, and sends a report to the police, the fire department, or the like. Further, the communication device 1 has a plurality of operation modes, as exemplified by a market mode and a factory mode. The market mode is a mode when the communication device 1 is used in a state where the communication device 1 is equipped in the vehicle after the shipment to the market. The factory mode is a mode when the operation of the communication device 1 is inspected in a factory before the shipment to the market. In the factory mode, even when the communication device 1 is electrically disconnected from the main battery 101, the activation process is continued by the electricity supply from the auxiliary battery 100. Consequently, although it takes a certain amount of time to complete the activation process, the main battery 101 can be used for other inspection items without the interruption of the activation process. Therefore, the inspection process can be shortened compared to a case where the main battery 101 is used for other inspection items after the completion of the activation process. On the other hand, in the market mode, when the communication device 1 is disconnected from the main battery 101, for example, due to an accident or the like, the activation process is stopped, and therefore the auxiliary battery 100 is preserved. Then, the communication device 1 receives the electricity supply from the auxiliary battery 100, and sends the report, and therefore, safety is assured. In this way, it is possible to streamline and improve the electricity supply method in the communication device 1.

### Exemplary Configuration of Communication Device 1

The communication device 1 includes the communication unit 11, a storage unit 12, the control unit 13, an input unit 15, an output unit 16, a detection unit 17, and an electric power source unit 18. One or more units of the respective units may be configured as one device, or may be configured by a terminal device such as a smartphone and a tablet terminal, a navigation device, or the like. Alternatively, the respective units may be connected through a within-vehicle network complying with a standard such as controller area network (CAN), such that information communication can be performed.

The communication unit 11 includes one or more communication interface. For example, the communication interface is an interface that corresponds to a mobile communication standard such as long term evolution (LTE), 4th generation (4G), or 5th generation (5G). The communication unit 11 receives information that is used for the operation of the control unit 13, and sends information that is obtained by the operation of the control unit 13. By the communication unit 11, the control unit 13 is connected, for example, to the internet, an ad-hoc network, a local area network (LAN), a metropolitan area network (MAN), another network, or a combination of them, through a base station for mobile communication.

For example, the storage unit 12 includes a main storage device, an auxiliary storage device, one or more semiconductor memories that function as cache memories, one or more magnetic memories, one or more optical memories, or a combination of at least two kinds of them. For example, the semiconductor memory is a random access memory (RAM) or a read only memory (ROM). For example, the RAM is a static RAM (SRAM) or a dynamic RAM (DRAM). For example, the ROM is an electrically erasable programmable ROM (EEPROM). For example, the storage unit 12 functions as a main storage device, an auxiliary storage device, or a cache memory. In the storage unit 12, the information that is used for the operation of the control unit 13 and the information that is obtained by the operation of the control unit 13 are stored. In the storage unit 12, mode information indicating the mode of the operation of the communication device 1 is stored. The mode information is information indicating one of the market mode and the factory mode. When the communication device 1 is produced, the mode information indicating the factory mode is stored in the storage unit 12, as an initial value.

The control unit 13 includes one or more processors, one or more dedicated circuits, or a combination of them. The processor is a general-purpose processor such as a central processing unit (CPU) or a dedicated processor for a specific process. For example, the dedicated circuit is a field-programmable gate array (FPGA) or an application-specific integrated circuit (ASIC). The control unit 13 executes information processing relevant to the control of each unit of the communication device 1.

The function of the control unit 13 is realized when a control program is executed by the processor included in the control unit 13. The control program is a program for causing a computer to execute a process in a step included in the operation of the control unit 13 and thereby causing the computer to realize a function corresponding to the process in the step. That is, the control program is a program for causing the computer to function as the control unit 13. Further, some or all of the functions of the control unit 13 may be realized by the dedicated circuit included in the control unit 13.

The input unit 15 includes one or more input interfaces. For example, the input interface is a physical key, a capacitance key, a pointing device, a touch screen that is provided integrally with a display, or a microphone that accepts a voice input. Furthermore, the input interfaces may include a camera that captures a pickup image or an image code, or an IC card reader. The input unit 15 accepts a handling for inputting the information that is used for the operation of the control unit 13, and sends the input information to the control unit 13.

The output unit 16 includes one or more output interfaces. For example, the output interface is a display or a speaker. For example, the display is a liquid crystal display (LCD) or an organic electro-luminescence (EL) display. The output unit 16 outputs the information that is obtained by the operation of the control unit 13.

The detection unit 17 includes interfaces for one or more sensors that detect states of parts of the vehicle equipped with the communication device 1. For example, the sensors include sensors that detect remaining battery levels of the main battery 101 and the auxiliary battery 100, sensors that detect motion states (velocity, front-rear-directional acceleration, right-left-directional acceleration, deceleration, and the like) of the vehicle, and the like. Further, the interfaces include interfaces for one or more global navigation satellite system (GNSS) receivers that detect position information. For example, the GNSS includes at least one of a global positioning system (GPS), a quasi-zenith satellite system (QZSS), BeiDou, a global navigation satellite system (GLONASS), and Galileo. The detection unit 17 sends the respective states obtained by the sensors and the like and the information indicating the position and the like, to the control unit 13.

The electric power source unit 18 includes an electric power source control circuit that is electrically connected with the main battery 101 and the auxiliary battery 100 and that controls the electricity supply from the main battery 101 and the auxiliary battery 100 to the communication device 1. The electric power source switch for turning on the electric power source to the communication device 1 is included in the electric power source unit 18. The electric power source unit 18 detects whether the electric power source unit 18 is electrically connected with the main battery 101. When the user turns on the ACC power source of the vehicle or the user turns on the electric power source switch in a state where the electric power source unit 18 is electrically connected with the main battery 101, the electric power source is turned on, and the electric power source unit 18 receives the electricity supply from the main battery 101, and supplies the electric power for activation, to the control unit 13 and the like. Further, when the electric power source is turned on in a state where the electric power source unit 18 is electrically disconnected from the main battery 101, the electric power source unit 18 receives the electricity supply from the auxiliary battery 100 instead of the main battery 101, and supplies the electric power for report operation, to the control unit 13, the communication unit 11, and the like. In the case where the communication device 1 is operating in the factory mode and where the control unit 13 is executing the activation process by receiving the electricity supply from the main battery 101 after the electric power source is turned on, when the electric power source unit 18 is electrically disconnected from the main battery 101, the electric power source unit 18 accepts the electricity supply from the auxiliary battery 100 and supplies electric power to the control unit 13 and the like, under the control by the control unit 13. Further, the electric power source unit 18 performs the reading of a variety of setting information including the mode information, and the like, by the electric power of a backup battery such as a complementary metal oxide semiconductor (CMOS) battery.

### Operation of Communication Device 1

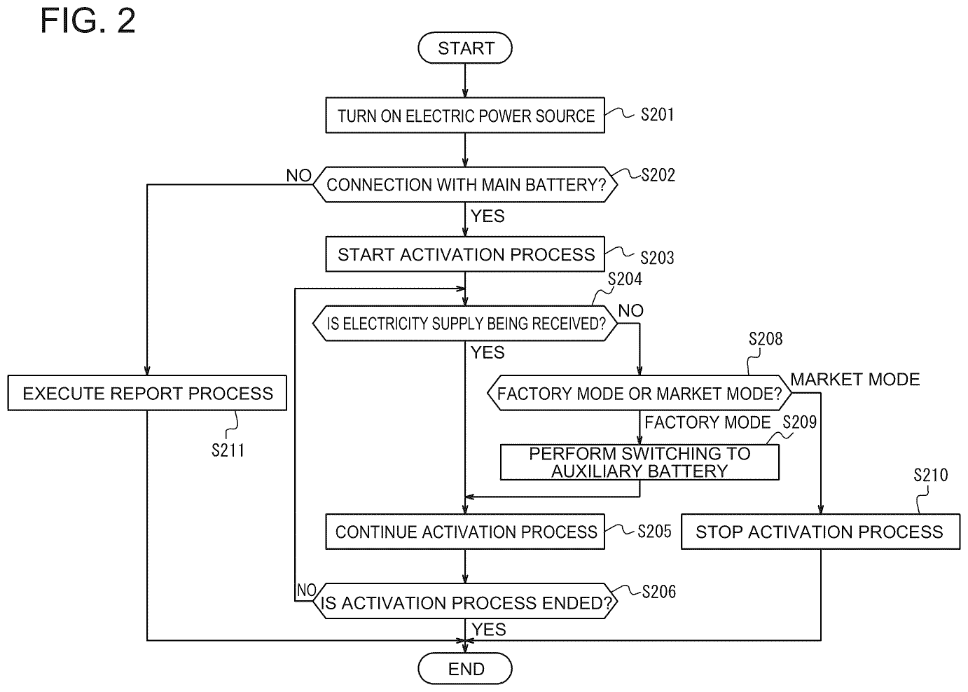

FIG. 2 is a flowchart for describing an exemplary operation procedure of the communication device 1. The case of the market mode and the case of the factory mode will be separately described below.

### Case of Market Mode

When the electric power source unit 18 detects that the electric power source has been turned on in step S201, the electric power source unit 18 determines whether the electric power source unit 18 is electrically connected with the main battery 101, in step S202. In the case where the electric power source unit 18 is electrically connected with the main battery 101 (Yes in step S202), the electric power source unit 18 receives the electricity supply from the main battery 101, and supplies the electric power to the control unit 13 and the like. Thereby, the control unit 13 executes step S203. On the other hand, in the case where the electric power source unit 18 is not electrically connected with the main battery 101 (No in step S202), the electric power source unit 18 receives the electricity supply from the auxiliary battery 100 instead of the main battery 101, and supplies the electric power to the control unit 13 and the like. Thereby, the control unit 13 executes step S211.

In step S203, the control unit 13 starts the activation process for activating the communication device 1. The activation process includes diagnosis processes of memories, processor, input and output devices, and the like, the activation of the operating system, the initialization of a communication interface, the establishment of network connection, and the like.

In step S204, it is determined whether the electric power source unit 18 is receiving the electricity supply. In the case where the electric power source unit 18 is receiving the electricity supply (Yes in step S204), the control unit 13 continues the activation process in step S205. Step S204 and step S205 are repeated until the control unit 13 determines the end of the activation process in step S206 (No in step S206). When the control unit 13 determines the end of the activation process in step S206 (Yes in step S206), the control unit 13 ends the procedure in FIG. 2. In this case, the control unit 13 completes the activation process by the electricity supply from the main battery 101.

In the case where the electric power source unit 18 is not receiving the electricity supply in step S204 (No in step S204), there is a high probability that the electric power source unit 18 is electrically disconnected from the main battery 101, and therefore the electric power source unit 18 determines the mode in step S208. The electric power source unit 18 refers to the mode information stored in the storage unit 12, by the electric power of the backup battery. On this occasion, the electric power source unit 18 makes the determination of the market mode. Then, the electric power source unit 18 does not perform the switching to the auxiliary battery 100, and the control unit 13 stops the activation process in step S210, and ends the procedure in FIG. 2.

In the case where the electric power source unit 18 is not electrically connected with the main battery 101 in step S202 (No in step S202), the electricity supply is received from the auxiliary battery 100 instead of the main battery 101. Then, the control unit 13 that receives the supply of the electric power executes a report process in step S211. For example, the control unit 13 sends information for report that is previously stored in the storage unit 12, to a management center such as the police and the fire department, through the communication unit 11. The information for report may include, for example, the position information about the vehicle that is acquired by the control unit 13 through the detection unit 17. Then, the control unit 13 ends the procedure in FIG. 2. By this operation, the safety of the vehicle equipped with the communication device 1 is assured.

### Case of Factory Mode

The case of the factory mode is different from the case of the market mode, in the procedure after step S208. When the electric power source unit 18 makes the determination of the factory mode in step S208, the electric power source unit 18 performs the switching to the electricity supply from the auxiliary battery 100 in step S209. Then, in step S205, the control unit 13 continues the activation process by receiving the electricity supply from the auxiliary battery 100. Step S204 and step S205 are repeated until the control unit 13 determines the end of the activation process in step S206 (No in step S206). On this occasion, in the case where the electric power source unit 18 is receiving the electricity supply from the auxiliary battery 100 in step S204 (Yes in step S204), step S205 is executed. Then, when the control unit 13 determines the end of the activation process in step S206 (Yes in step S206), the control unit 13 ends the procedure in FIG. 2. In this case, the control unit 13 completes the activation process by the electricity supply from the auxiliary battery 100, even after the electricity supply from the main battery 101 is stopped.

In the case of the factory mode, the communication device 1 is activated in the above-describe procedure, and therefore, in the communication device 1, it is possible to execute various inspections before the shipment to the market. In the communication device 1, the control unit 13 may execute various inspections based on information about inspection items that is previously stored in the storage unit 12, or may execute various inspections in response to an input by a worker. In this case, even when the communication device 1 is electrically disconnected with the main battery 101 at the time of the factory mode, the activation is completed by the electricity supply from the auxiliary battery 100. Consequently, although it takes a certain amount of time to complete the activation process, the main battery 101 can be used for other inspection items without the interruption of the activation process. Therefore, the inspection process can be shortened compared to a case where the main battery 101 is used for other inspection items after the completion of the activation process.

Operation after Inspection

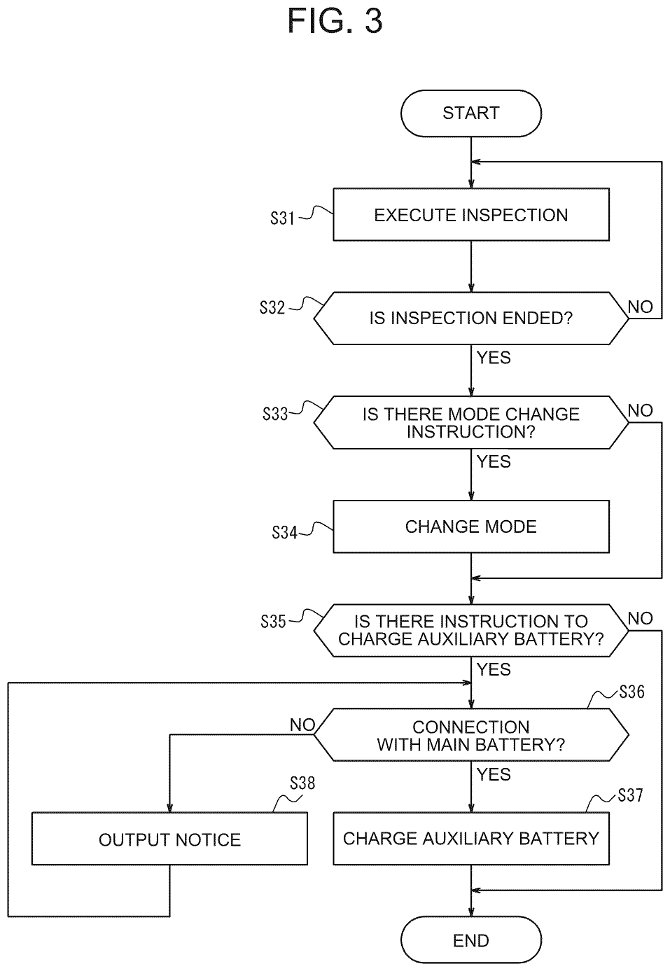

FIG. 3 is a flowchart for describing an exemplary operation procedure of the communication device 1 during the inspection in the factory mode and after the inspection.

In step S31, the control unit 13 executes information processing relevant to the inspection. Examples of the inspection item include an electric power source voltage inspection, operation inspections of memories, processors, input and output devices, and the like, an operation inspection of a communication interface, a network connection inspection, a signal quality inspection, a security inspection, and a throughput inspection. The control unit 13 executes step S31 until the end of the inspection is determined in step S32 (No in step S32), and proceeds to step S33 when the end of the inspection is determined (Yes in step S32).

In step S33, the control unit 13 determines whether there is an instruction to change the mode. For example, the user performs, to the input unit 15, a handling for giving an instruction to end the factory mode or to change from the factory mode to the market mode. The control unit 13 determines whether there is an input corresponding to this handling. In the case where the control unit 13 has received the instruction to change the mode (Yes in step S33), the control unit 13 changes the mode in step S34. The control unit 13 changes the mode information indicating the factory mode set as the initial value, to the mode information indicating the market mode, and stores the changed mode information in the storage unit 12. As a procedure in a modification, when the control unit 13 ends a sequence of inspections, the control unit 13 may skip step S33, and may change the mode.

In step S35, the control unit 13 determines whether there is an instruction to charge the auxiliary battery 100. For example, the user performs, to the input unit 15, a handing for giving the instruction to charge the auxiliary battery 100. The control unit 13 determines whether there is an input corresponding to this handling. In the case where the control unit 13 has received the instruction to charge the auxiliary battery 100 (Yes in step S35), the control unit 13 performs the determination about the connection with the main battery 101, in step S36. In the case where the electric power source unit 18 is electrically connected with the main battery 101 (Yes in step S36), the control unit 13 gives, to the electric power source unit 18, an instruction to charge the auxiliary battery 100 by the electricity supply from the main battery 101, in step S37. Thereby, the auxiliary battery 100 is charged by the main battery 101. On the other hand, in the case where the electric power source unit 18 is not electrically connected with the main battery 101 (No in step S36), the control unit 13 outputs a notice through the output unit 16, in step S38. The notice is textual information or the like for prompting the connection of the main battery 101 with the communication device 1. Then, step S36 is executed. In a modification, the control unit 13 may skip step S35, and may execute charging of the auxiliary battery 100 by the main battery 101.

In the above-described procedure, after the end of the inspection, the mode of the communication device 1 can be changed to the market mode for the shipment to the market. Further, even when the electric power of the auxiliary battery 100 is consumed for the activation process in the factory mode, the remaining level of the auxiliary battery 100 can be recovered before the shipment to the market.

The embodiment has been described above based on the drawings and the examples. Note that a person skilled in the art can easily make various modifications and alterations based on the present disclosure. Accordingly, it should be understood that the modifications and the alterations are included in the scope of the present disclosure. For example, the functions and the like included in the respective means, respective steps, and the like can be rearranged such that there is no logical inconsistency, and a plurality of means, a plurality of steps, or the like can be combined to one means, one step, or the like, or can be divided.

What is claimed is:

1. A communication device comprising:
a communication unit; and
a control unit that executes an activation process by receiving electricity supply from an external battery or sends a report through the communication unit by receiving electricity supply from an internal battery instead of the external battery, when an electric power source is turned on, wherein
the control unit has a first mode in which the control unit continues the activation process by the electricity supply from the internal battery, when the electricity supply from the external battery is stopped during the execution of the activation process.

2. The communication device according to claim 1, further comprising an input unit that accepts an instruction from a user, wherein
after the control unit operates in the first mode and ends the activation process, the control unit performs switching from the first mode to a second mode in response to a predetermined instruction, the second mode being a mode in which the control unit stops the activation process when the electricity supply from the external battery is stopped during the execution of the activation process.

3. The communication device according to claim 1, wherein after the control unit operates in the first mode and ends the activation process, the control unit charges the internal battery by the electricity supply from the external battery.

4. An operation method of a communication device that includes a communication unit and a control unit, wherein:
the control unit executes an activation process by receiving electricity supply from an external battery or sends a report through the communication unit by receiving electricity supply from an internal battery instead of the external battery, when an electric power source is turned on; and
in a first mode, the control unit continues the activation process by the electricity supply from the internal battery, when the electricity supply from the external battery is stopped during the execution of the activation process.

5. The operation method of the communication device according to claim 4, wherein after the control unit operates in the first mode and ends the activation process, the control unit performs switching from the first mode to a second mode in response to a predetermined instruction, the second mode being a mode in which the control unit stops the activation process when the electricity supply from the external battery is stopped during the execution of the activation process.
